(19) United States
(12) Patent Application Publication
(10) Pub. No.: US 2005/0188008 A1
(43) Pub. Date: Aug. 25, 2005

(54) System for communicating with servers using message definitions

(76) Inventor: Boris Weissman, Mountain View, CA (US)

Correspondence Address: PERKINS COIE LLP;PATENT-SEA, P.O. BOX 1247, SEATTLE, WA, 98111-1247, US

(21) Appl. No.: 10/867,557

(22) Filed: Jun. 14, 2004

Related U.S. Application Data
(63) Continuation of application No. 09/790,256, filed on Feb. 21, 2001, now abandoned.

(30) Foreign Application Priority Data
Jul. 11, 2002 (FR) EN.02/08.714

(51) Int. Cl. G06F 15/173; G06F 15/16

(52) U.S. Cl. 709/203; 709/206

(57) ABSTRACT

A method and system for providing a single logon system for logging onto multiple server computers without modification of the server computers. The logon system is provided by a portal computer that implements a portal web site through which users of client computers can access multiple server computers that implement various “accessible” web sites. The portal web site provides to the client computers web pages with links that each identify accessible web sites. When a user of a client computer selects a link to an accessible web site, a message is sent to the portal web site that identifies the accessible web site. The portal web site uses the definition of logon messages to control the logging on of the user to the identified web site in such a way that the logon appears to the identified web site as being performed by the user and that the identified web site does not need to be modified to accommodate the logging on of the user via the portal web site.

A portion of this disclosure contains material to which a claim for copyright is made. The copyright owner has no objection to the facsimile reproduction by anyone of the patent document or the patent disclosure (including Figures), as it appears in the Patent and Trademark Office patent file or records, but reserves all other copyright rights whatsoever.

### TECHNICAL FIELD

The described technology relates in general to logging on to a server computer and, in particular, to logging on to multiple servers through a portal computer.

### BACKGROUND

Many organizations (e.g., corporations) have found it desirable to provide web sites through which users (e.g., customers) can access the web pages of the organization. These web sites may be used to conduct electronic commerce or to disseminate information about the organization. The goal of many of these organizations is to have as many users as possible visit their web sites. In order to support a large number of visits, these organizations often develop complex computer system infrastructures. These infrastructures may include firewalls, load balancers, web servers, application servers, and so on. As the number of visits increases, additional computers need to be added to the infrastructure. Organizations may find it very expensive and time consuming to design, build, and maintain the necessary computer system infrastructure using their internal information technology group. In addition, there may be a shortage of information technology personnel who are qualified to work on such computer system infrastructures. As a result, these organizations may outsource the management of their web sites to a hosting service. A hosting service may provide the infrastructure, both hardware and software, to support the web sites of their customer organizations. The customer organizations need only provide their domain-specific applications, which can be served by the computer system infrastructure of the hosting service. The use of a hosting service allows a customer organization to concentrate its efforts on its domain-specific applications, and allows the hosting service to cost effectively manage the infrastructure needed by multiple customer organizations.

These web sites are typically part of the World Wide Web (“WWW”). The WWW allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”), which is a type of Uniform Resource Identifier (“URI”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special-purpose application program that effects the requesting and displaying of web pages.

Currently, web pages are generally defined using HyperText Markup Language (“HTML”). HTML provides a standard set of tags that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as defined by the HTML document. The HTML document contains various tags that control the displaying of text, graphics, controls, and other features. The HTML document may contain URLs of other web pages available on that server computer system or other server computer systems.

It is, of course, useful for a provider of a web site to analyze the performance of the web site to ensure that the user's requests are being serviced in a timely manner and that the overall experience of visiting the web site improves the chances of attracting and retaining the user. Many web sites have been developed to assist in the evaluation of the performance of other web sites. Such a performance evaluation web site may, for example, provide services to analyze the click stream files generated by a web site, to analyze web page access patterns, to analyze the number of HTTP messages received, and so on. A web site provider who has access to such performance information can modify the web site or the computer systems that support the web site. Because many performance evaluation web sites are currently available, it is difficult for a provider of a web site to identify and access a performance evaluation web site that can best provide the analysis needed to assist the provider. Even if a provider could determine which performance evaluation web sites could best meet its needs, it may be cumbersome and time-consuming to access multiple web sites. Part of the problem in accessing such diverse performance evaluation web sites is that each web site typically requires that the user “logon” to that web site in order to use services of the web site. Unfortunately, there is no universally accepted standard for logging on to a web site. For example, some web sites require that a user name and password be entered into the appropriate fields of a web page. These web sites, however, may specify very different criteria for a valid user name and password. In particular, some web sites may require that passwords be eight or more characters and include at least one numeric character, while other web sites may require that passwords be five to seven characters and include no numeric characters. The same password, of course, could not be used for both web sites. Also, some web sites may use logon procedures defined by certain standards (e.g., HTTP 1.1), and other web sites may use logon procedures that are customized to the web site. This incompatibility between criteria and procedures, along with the inconvenience of multiple logons and of re-logging on after a web site logon connection has timed out, contributes greatly to the difficulty of using such performance evaluation web sites.

Portal web sites have been developed to improve a user's experience in using the World Wide Web. A portal web site typically provides access to other web sites that are related in some way. For example, shopping portal web sites provides links to other web sites through which a user can purchase items. A portal web site may be attractive to users for several reasons. First, a portal web site may provide links to obscure web sites of which the user may not be aware. (The providers of the obscure web sites find the use of a portal web site advantageous because the portal web site acts as an advertiser for the obscure web sites.) Second, a portal web site may provide search capabilities that allow a user to search multiple web sites simultaneously. Third, some portal web sites provide a single logon mechanism that allows a user of the portal web site to be automatically logged on to the web sites accessible through the portal. The single logon mechanism of these portal web sites, however, has disadvantages. For example, one disadvantage is that each web site accessed via the portal web site may need to change its logon procedure to be compatible with that of the portal web site. Although this may not be a serious disadvantage if the web site is accessed through only one portal web site, it becomes a serious disadvantage when the web site is accessed through multiple portal web sites. The accessible web site would need to support the different logon procedures required by each portal web site. Currently available solutions typically involve installation of custom software on all sites that wish to be accessible via a single portal. This is subject to the availability of single sign-on plugins for different software environments and has associated costs as well as maintenance overhead. It would be desirable to have a system by which a portal web site can provide a single logon to various web sites with different logon procedures without having to modify the web sites that are accessed.

### BRIEF DESCRIPTION OF THE DRAWINGS

FIG. 1 illustrates a web page provided by a portal web site for accessing accessible web sites.

FIG. 2 illustrates a web page provided by an accessible web site through the portal web site.

FIG. 3 is a block diagram illustrating components of the logon system in one embodiment.

FIG. 4 is a flow diagram illustrating the processing of the present channels component in one embodiment.

FIG. 5 is a flow diagram illustrating the processing of the process the channel selection component of the forward message component in one embodiment.

FIG. 6 is a flow diagram illustrating the processing of the logon component in one embodiment.

FIG. 7 is a flow diagram illustrating the processing of the authorize using HTTP function in one embodiment.

FIG. 8 is a flow diagram illustrating the processing of the authorizing using forms function in one embodiment.

FIG. 9 is a flow diagram illustrating the processing of the received in HTTP message from a server function of the forward message component in one embodiment.

FIG. 10 is a flow diagram illustrating the processing of the receive HTTP message from client function of the forward message component in one embodiment.

### DETAILED DESCRIPTION

A method and system for providing a single logon system for logging onto multiple server computers without modification of the server computers is provided. In one embodiment, the logon system is provided by a portal computer that implements a portal web site through which users of client computers can access multiple server computers that implement various “accessible” web sites. The portal web site provides to the client computers web pages with links that each identify accessible web sites. When a user of a client computer selects a link to an accessible web site, a message is sent to the portal web site that identifies the accessible web site. The portal web site determines whether the user of the client computer is currently logged on to the identified the web site. If the user is not logged on, the portal web site retrieves logon information that defines how the portal web site can log the user on to the identified web site. The portal web site may store the logon information, which may include a user name and password and a definition of logon messages to be used to effect the logging on of the user to the identified web site. The portal web site uses the definition of logon messages to control the logging on of the user to the identified web site in such a way that the logon appears to the identified web site as being performed by the user, and that the identified web site does not need to be modified to accommodate the logging on of the user via the portal web site. In this way, the portal web site can provide a single logon capability for multiple accessible web sites that support different logon procedures without the need to modify those accessible web sites.

In one embodiment, the logon system maintains a channel database that defines the messages used to effect the logon to each accessible web site. Each channel corresponds generally to an accessible web site or portion of an accessible web site. For each accessible web site, the channel database has a logon definition that specifies the sequence of one or more message definitions that define the messages used to log a user onto that accessible web site. The logon system may provide special codes to indicate that the logon procedure of a web site is a certain standard logon procedure without having to define each of the messages. The logon system uses the message definition to define the logon procedures of web sites that are different from these standard procedures. Each message definition may specify an HTTP-get or an HTTP-post message. An HTTP-get message definition may specify a uniform resource locator and may optionally specify a name. The URL identifies a resource of the accessible web site, and the name specifies the internal name of the resource (e.g., web page) provided by the accessible web site in the response message. The HTTP-post message definition, like the HTTP-get message definition, may specify a URL and optionally a name, but also may specify data to be included with the HTTP-post message. The data for the HTTP-post message may include a reference to authentication information (e.g., user name and password) for the user that is to be logged on to the accessible web site. In addition, the HTTP-post message definition may include a reference to a resource previously received in response to a message being sent during the logon process. For example, some logon procedures require that a nonce be provided by their web page to be used to encode the authentication information sent from the client computer. The logon system in one embodiment uses a hierarchical naming scheme to identify data provided by previously received resources during the logon procedure. For example, an HTTP-get message definition may define that the returned web page is named “logonpage.” A logon form within the returned web page may be named “logonform.” A subsequent HTTP message definition may refer to that form as “logonpage.logonform.” In one embodiment, the message definitions are specified using Extensible Markup Language (“XML”) as defined by an XML schema.

The logon system of the portal computer also stores the cookies provided by the various accessible web sites. When the logon system receives a message from a web site that includes a cookie, it stores the cookie in its cookie database identified by the client computer and the web site that sent the cookie. (The web site is actually identified by its domain name, e.g., “CompanyA.com.”) The logon system then forwards the message without the cookies to the client computer. When the portal web site subsequently receives a message of from the client computer that is to be forwarded to that accessible web site, the logon system retrieves the cookies stored for that client computer and for the domain of that web site. The portal web site adds the cookies to the message and then forwards the message with those cookies to the accessible web site. In this way, the logon system avoids the limitation associated with some browsers that limit the number of cookies that can be stored for each domain. For example, the Internet Engineering Task Force has promulgated RFC2965 entitled “HTTP State Management Mechanism (Cookies)” that requires browsers to store at least 20 cookies per domain (ftp://ftp.isi.edu/in-notes/rfc2965.txt). If the portal web site forwarded the cookies of the accessible web sites to the client computers, the cookies would be stored under the domain of the portal web site and this limitation might easily be exceeded. The logon system of the portal web site also rewrites the links (e.g., URLs) of the web pages that are provided to the client computers. The links are rewritten to refer to the portal web site, rather than the accessible web site. This allows the portal web site to receive the HTTP-get and HTTP-post messages and forward them from the portal web site to the accessible web site via the secure connection that was established during logon. This also allows the portal web site to add the cookies and potentially other HTTP headers as appropriate before forwarding the message to the accessible web site.

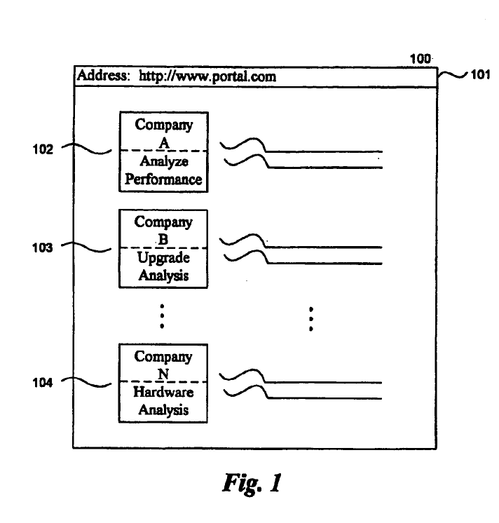

FIG. 1 illustrates a web page provided by a portal web site for accessing accessible web sites. Web page 100 includes address information 101, link 102 to Company A, link 103 to Company B, and link 104 to Company N. The portal web site provides this web page after a user logs on to the portal web site using authentication information defined for the portal web site. This logon to the portal web site is referred to as the single logon because the portal web site automatically logs on to the accessible web sites on behalf of the user after the user logs on to the portal web site. The portal web site may communicate with the client computers using a secure protocol such as an HTTP Secure Socket Layer protocol (i.e., HTTPS). The address information indicates the URL associated with the displayed web page. When a user selects one of the links 102-104, the client computer sends a message (e.g., HTTP-get message) to the portal web site. The message identifies the client computer, a port on the client computer, and the domain of the company associated with selected link. Upon receiving the message, the portal web site identifies the user of the client computer and logs the user on to the domain of the company, if the user is not already logged on. The portal web site then adds cookies to the message, as appropriate, and then forwards the message on to the accessible web site associated with the link that the user selected.

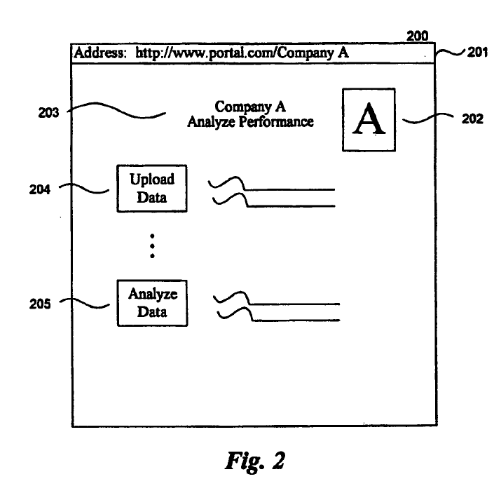

FIG. 2 illustrates a web page provided by an accessible web site through the portal web site. Web page 200 includes address information 201, company logo 202, company name 203, and resource links 204-205. When the portal web site received this web page from the accessible web site, it identified the links, such as resource links 204-205, and rewrote those links so that the message associated with those links would be sent to the portal web site, rather than the accessible web site (or any other web site to which they were directed). The portal web site stores information so that it can redirect such rewritten links to the appropriate web site. This information may be stored after the domain name in the URL, sent to the client computer, and returned when the user selects the link. In addition, the portal web site stores any cookies included in the message that accompanied the web page and removes those cookies before forwarding the web page to the client computer. The address information indicates that this web page is associated with a URL that identifies the portal web site. The company logo and company name are provided by the web page sent from the accessible web site. The images of the resource links are also provided by the accessible web site; however, the domains associated with the resource links have been modified to point to the portal web site.

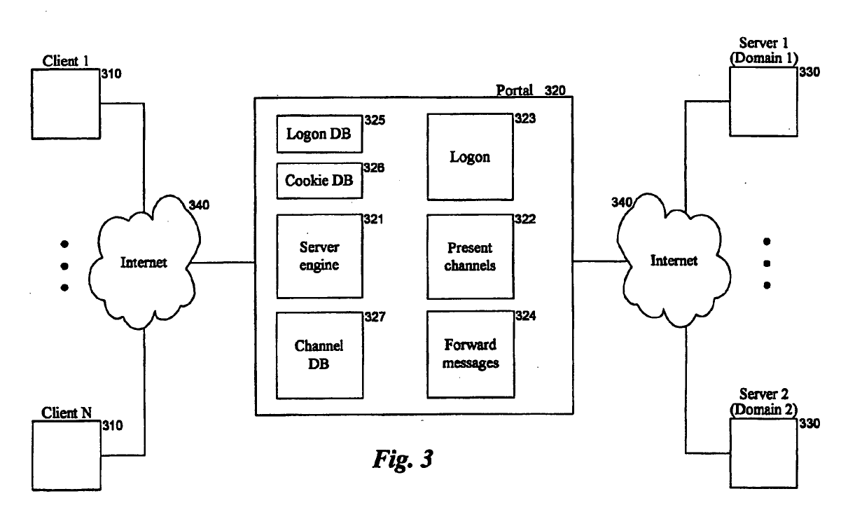

FIG. 3 is a block diagram illustrating components of the logon system in one embodiment. The logon system includes client computers 310, portal computer 320, and domain server computers 330, all interconnected via the Internet 340. The computers may include a central processing unit, memory, input devices (e.g., keyboard and pointing device), output devices (e.g., display devices), and storage devices (e.g., disk drives). The memory and storage devices are computer-readable media that may contain computer instructions and data structures that implement the logon system. The client computers use browsers to access the web pages via the Internet. One skilled in the art will appreciate that the concepts of the logon system can be used in various environments other than the Internet. Also, various communication channels such as a local area network, a wide area network, or a point-to-point dial-up connection may be used instead of the Internet. The computer systems may comprise a combination of hardware and software that can support these concepts. In particular, the portal computer and server computers may actually include multiple computers. A client system may comprise any combination of hardware and software that interact with server systems.

The portal computer includes a server engine 321, a present channels component 322, a logon component 323, a forward message component 324, a logon database 325, a cookie database 326, and a channel database 327. These components and databases illustrate the functions of the logon system. One skilled in the art would appreciate that the actual organization of the components and databases can be different. The server engine receives requests for resources (e.g., web pages) from client computers via the Internet and coordinates the generation and transmission of the resources. The present channels component generates the web pages, such as that shown in FIG. 1, that provide the links through which a user can access the various channels (e.g., accessible web sites). The channels accessible to a user may be customized to that user. The channel database has an entry for each user that lists the channels accessible to that user. The channel information for each channel is described in XML using the RDF Site Summary (“RSS”) specification as developed by Netscape Corporation (http://my.netscape.com/publish/help/quickstart.html). The Research Description Framework (“RDF”) is described in a World Wide Web Consortium document entitled “RDF Model and Syntax Specification” (http://www.w3c.org/TR/REC-rdf-syntax). As discussed below, a special “authorization” tag has been defined to supplement RSS to support the logon system. The authorization tag contains the logon message definitions for the associated channel. The logon component controls the logging on of a user to the accessible web sites in accordance with the information stored in the logon database and the channel database. The logon database specifies for each user the authentication information (e.g., user name and password) associated with the user for each channel or domain. The forward messages component receives messages from the client computers and server computers, processes the messages, and forwards them on to the server computers and client computers as appropriate. The forward messages component invokes the logon system to log the users onto the accessible web sites. The cookie database contains the cookies received from the accessible web sites.

Table 1 contains the schema for the authorization tag that supplements the RSS schema to support the logon system. The schema defines five tags: authorization (lines 1-8), form (lines 9-14), get (lines 15-22), post (lines 23-30), and http (lines 31-38). The authorization tag includes a form or an http tag and a domain attribute (line 5) for indicating the domain to which this authorization tag applies. The http tag is used to identify one of the standard HTTP-related authorization schemes, such as the basic protection scheme (using base64 encoding) and the digest protection scheme (using MD5 encoding). The scheme attribute of the http tag is used to specify one of the encoding schemes, and the realm attribute specifies the realm to which this authorization scheme is to apply. The form tag is used to define logon procedures that do not follow one of the standard HTTP-related authorization schemes. The form tag includes a sequence of get or post tags that are the message definitions that define the messages used to implement the logon procedure for the domain of the authorization tag. The get message tag includes a name attribute and a url attribute. The name attribute is used internally by the logon system to name the web page returned in response to sending the get message. Subsequent messages defined in the form tag can use this name to identify portions of the returned web page, such as nonce included in the web page. The url attribute identifies the resource to be accessed by the get message. The post tag includes a data tag, a name attribute, and a url attribute. The data tag is used to define data to be included in the post message. The name and url attributes have the same meaning as the corresponding attributes of the get tag. An authorization tag is added to an RSS document that defines channels and applies to each channel with the same domain as indicated in the domain attribute of the authorization tag.

TABLE 1

| | |
|---|---|
| 1 | <xsd:element name=“authorization”> |

| | |
|---|---|
| 2 | <xsd:type> |

| | |
|---|---|
| 3 | <xsd:element ref=“form” minOccurs=“0” |
| | maxOccurs=“1”/> |
| 4 | <xsd:element ref=“http” minOccurs=“0” |
| | max0ccurs=“1”/> |
| 5 | <xsd:attribute name=“domain” type=“string” |
| | minOccurs=“1” |

| | |
|---|---|
| 6 | maxOccurs=“1”/> |

| | |
|---|---|
| 7 | </xsd:type> |

| | |
|---|---|
| 8 | </xsd:element> |
| 9 | <xsd:element name=“form”> |

| | |
|---|---|
| 10 | <xsd:type> |

| | |
|---|---|
| 11 | <xed:element ref=“get” minOccurs=“0”/> |
| 12 | <xsd:element ref=“post” minOccurs=“0”/> |

| | |
|---|---|
| 13 | </xsd:type> |

| | |
|---|---|
| 14 | </xsd:element> |
| 15 | <xsd:element name=“get”> |

| | |
|---|---|
| 16 | <xsd:type content=“empty”> |

| | |
|---|---|
| 17 | <xsd:attribute name=“name” type=“string” |
| | minOccurs=“0” |

| | |
|---|---|
| 18 | max0ccurs=“1”/> |

| | |
|---|---|
| 19 | <xsd:attributename=“url” type=“string” |
| | minOccurs=“0” |

| | |
|---|---|
| 20 | maxOccurs=“1”/> |

| | |
|---|---|
| 21 | </xsd:type> |

| | |
|---|---|
| 22 | </xsd:element> |
| 23 | <xsd:element name=“post”> |

| | |
|---|---|
| 24 | <xsd:type> |

| | |
|---|---|
| 25 | <xsd:element ref=“data” minOccurs=“1” |
| | maxOccurs=“1”/> |
| 26 | <xsd:attribute name=“name” type=“string” |
| | minOccurs=“0” |

| | |
|---|---|
| 27 | maxOccurs=“1”/> |

| | |
|---|---|
| 28 | <xsd:attribute name=“url” type=“string” |
| | minOccurs=“1” maxOccurs=“1”/> |
| 29 | </xsd:type> |

| | |
|---|---|
| 30 | </xsd:element> |
| 31 | <xsd:element name=“http”> |

| | |
|---|---|
| 32 | <xsd:type> |

| | |
|---|---|
| 33 | <xsd:attribute name=“scheme” type=“string” |
| | minOccurs=“1” |

| | |
|---|---|
| 34 | maxOccurs=“1”/> |

| | |
|---|---|
| 35 | <xsd:attribute name=“realm” type=“string” |
| | minOccurs=“1” |

| | |
|---|---|
| 36 | maxOccurs=“1”/> |

| | |
|---|---|
| 37 | </xsd:type> |

| | |
|---|---|
| 38 | </xsd:element> |

Table 2 illustrates an example XML description for a channel corresponding to the web site of Company A. The XML description uses an authorization tag (lines 3-5) and a channel tag (lines 6-16). The authorization tag defines that the logon procedure for the specified channel is the HTTP digest scheme and the logon procedure is to be applied to each channel within the XML document that matches the domain “CompanyA.com.” If multiple authorization tags match the domain of a channel, then the logon procedures defined by the authorization tags are applied in sequence. The channel tag defines the channel content in accordance with the RSS specification.

TABLE 2

| | |
|---|---|
| 1 | <?xml version=“1.0”?> |

| | |
|---|---|
| 2 | <rss version=“0.91”> |

| | |
|---|---|
| 3 | <authorization domain=“CompanyA.com”> |

| | |
|---|---|
| 4 | <http scheme=“Digest” realm=“geeks”/> |

| | |
|---|---|
| 5 | </authorization> |
| 6 | <channel> |

| | |
|---|---|
| 7 | <title>CompanyA</title> |
| 8 | <link>www.CompanyA.com</link> |
| 9 | <item> |

| | |
|---|---|
| 10 | <title>CompanyA</title> |
| 11 | <link>http://www.CompanyA.com:8080></link> |
| 12 | <description> |

| | |
|---|---|
| 13 | AnalyzeData |

| | |
|---|---|
| 14 | </description> |

| | |
|---|---|
| 15 | </item> |

| | |
|---|---|
| 16 | </channel> |

| | |
|---|---|
| 17 | <rss |

Table 3 illustrates an example authorization tag that uses the form tag. The authorization applies to channels with the domain of “my.CompanyB.com.” When a channel associated with that domain is selected by a user, then the logon system sends an HTTP-get message that identifies the resource “my.CompanyB.com/login.jsp?loginname=$(USER)&amp;password=$(PASSWORD).” The $(USER) and %(PASSWORD) indicate that the logon system substitutes the user name and password for the user that is stored in the logon database for that domain.

TABLE 3

| | |
|---|---|
| 1 | <authorization domain=“my.CompanyB.com”> |

| | |
|---|---|
| 2 | <form> |

| | |
|---|---|
| 3 | <get url=“http://my.CompanyB.com/login.jsp? |
| | loginname=$(USER)&amp; |

password=$(PASSWORD)”/>

| | |
|---|---|
| 4 | </form> |

| | |
|---|---|
| 5 | </authorization> |

Table 4 illustrates an HTML form tag of a web page for controlling logging on a user to the domain of “my.CompanyB.com.” The form tag indicates that the user inputs some query and indicates that the value of the realm “authorizationrealm1234” is sent to the client computer by the server computer. The action attribute identifies the destination to where the form data should be sent after it is entered by the user.

TABLE 4

| | |
|---|---|
| 1 | <form name=“loginform” action=“http://my.CompanyB.com/ |
| | processLogin.jsp> |

| | |
|---|---|
| 2 | <input name=“realm” value=“[authorization realm 1234]” |

| | |
|---|---|
| 3 | type=“hidden”>/ |

| | |
|---|---|
| 4 | <input name=“query” type=“TEXT”> |

| | |
|---|---|
| 5 | </form> |

Table 5 illustrates an example authorization tag of the RSS document that corresponds to the form tag of Table 4. The get tag of line 3 indicates that an HTTP-get message is to be sent with the identified URL. The returned resource (i.e., the web page that includes the form of Table 4) is named by the logon system as “loginpage.” When the filled in form is received by the portal web site, the logon system sends an HTTP-post message as indicated by the post tag at lines 4-8. The logon system substitutes for “$(loginpage.loginform.action)” of the post tag the value of the “action” attribute of the “loginform” of the “loginpage,” which is “http://myCompanyB.com/processloginjsp.” The logon system also substitutes for “$(loginpage.loginform.realm.value)” the value of the “value” attribute of the “realm” input tag of the “loginform” of the “loginpage.” The user name and password are substituted as described above. The logon system sends the post message to complete the logon.

TABLE 5

| | |
|---|---|
| 1 | <authorization domain=“my.company.com”> |

| | |
|---|---|
| 2 | <form> |

| | |
|---|---|
| 3 | <get name=“loginpage” url=“http://my.company.com/ |
| | login.jsp”> |
| 4 | <post url=“$(loginpage.loginform.action)”> |

| | |
|---|---|
| 5 | <data>realm=$(loginpage.loginform.realm. |
| | value)&amp; |

| | |
|---|---|
| 6 | user name=$( USER) &amp;password= |
| | $(PASSWORD) |

| | |
|---|---|
| 7 | </data> |

| | |
|---|---|
| 8 | </post> |

| | |
|---|---|
| 9 | </form> |

| | |
|---|---|
| 10 | </authorization> |

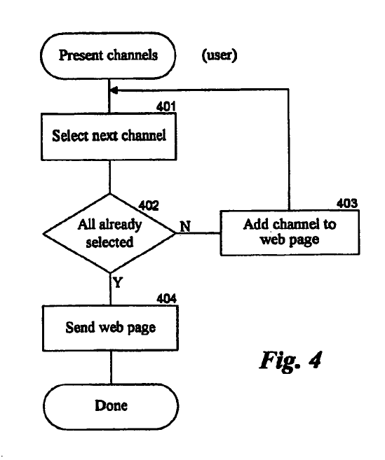

FIG. 4 is a flow diagram illustrating the processing of the present channels component in one embodiment. This component is invoked when a user requests to view the channels that are available to them. The component is passed an indication of the user. In block 401, the component selects the next channel associated with that user starting with the first. The channels for each user are specified in the channel database. The database may contain an XML document complying with the RSS specification as extended by the form tag of the logon system. The database may also contain a mapping from those users to the XML document specifying the channels that the user is authorized to access. The user to channel mapping may be created using conventional techniques similar to those used to customize “my” web pages. In decision block 402, if all the channels associated with the user have already been selected, then the component continues at block 404, else the component continues at block 403. In block 403, the component adds the link for the selected channel to a web page and then loops to block 401 to select the next channel. In block 404, the component sends the web page to the client computer of the user and then completes.

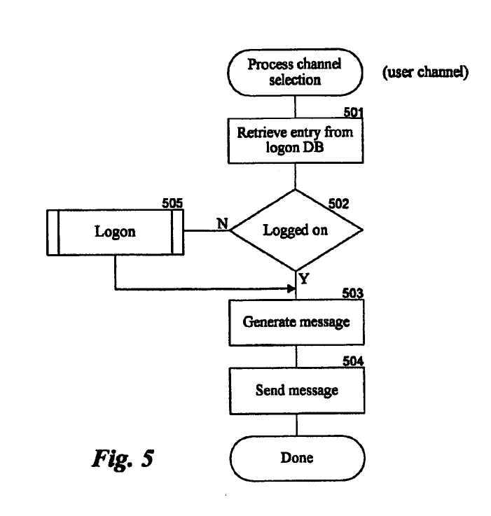

FIG. 5 is a flow diagram illustrating the processing of the process channel selection component of the forward message component in one embodiment. This component is invoked when a message is received indicating that a user has selected a channel that is displayed. The component is passed an indication of the user and the selected channel. In block 501, the component retrieves the entry from the logon database for the user. The logon database includes an entry for each user that includes authentication information for the domain of each channel the user is authorized to access. In decision block 502, if the user is currently logged on to the channel, then the component continues at block 503, else the component continues at block 505. In block 503, the component generates a message to send to the URL identified by the channel. To generate the message, the component adds cookies to the message as indicated by the cookies database and sets the URL of the message to the URL of the channel. Depending on the authorization scheme, other HTTP headers may be added to the message. In block 504, the component sends the message and then completes. In block 505, the component invokes the logon component to coordinate the logging on of the user to the domain of the selected channel. The component then continues to block 503 thereby hiding the logon process from the user.

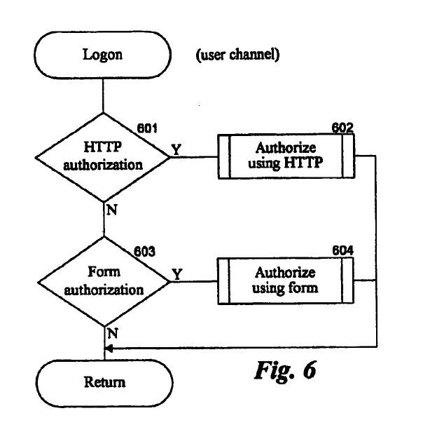

FIG. 6 is a flow diagram illustrating the processing of the logon component in one embodiment. The logon component is invoked when a user requests to access a channel for which the user is not currently logged on. The component is passed an indication of the user and the channel. The component initially retrieves the channel definition from the channel database. If no authorization tag is specified, then the component returns. Otherwise, in decision block 601, if the authorization tag indicates “http,” then the component continues at block 602, else the component continues at block 603. In block 602, the component invokes the authorize using HTTP function to coordinate the logon of the user using one of the standard HTTP procedures such as Basic or Digest authentication and then returns. In decision block 603, if the authorization tag indicates “form,” then the component continues at block 604, else the component returns. In block 604, the component invokes the authorize using form function to coordinate the logon of the user using custom procedures and then returns. The component may repeat this process for each authorization tag associated with the channel definition (i.e., with the same domain).

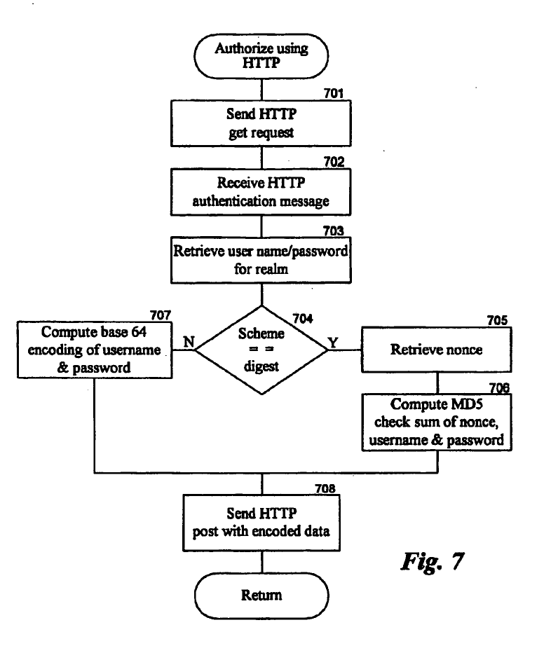

FIG. 7 is a flow diagram illustrating the processing of the “authorize using HTTP” function in one embodiment. In block 701, the function sends an HTTP-get request for the URL identified by the channel information. In block 702, the function receives the HTTP-authentication message from the web site indicating that the user is not currently logged on. In block 703, the function retrieves the authentication information (e.g., user name and password) for the realm identified in the HTTP-authentication message. In decision block 704, if the scheme attribute of the HTTP tag indicates “Digest,” then the function continues at block 705, else the function continues at block 707. In block 705, the function retrieves the nonce associated with the received HTTP-authentication message. In block 706, the function computes the MD5 checksum encoding using the nonce, user name, and password. In block 707, the function computes the base64 encoding of the user name and password. In block 708, the function sends an HTTP-post message with the encoded data to the URL of the channel. The function then returns.

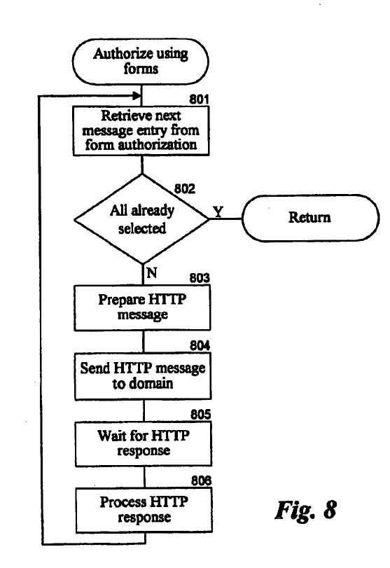

FIG. 8 is a flow diagram illustrating the processing of the “authorize using forms” function in one embodiment. This function loops selecting each message definition (i.e., get tag or post tag) in the authorization tag and processing that message definition. In block 801, the function retrieves the next message definition from the authorization tag. In decision block 802, if all the message definitions have already been selected, then the function returns, else the function continues at block 803. In block 803, the function prepares the HTTP message defined by the retrieved message definition. Such preparation may involve appending authentication credentials stored in the logon database and other information extracted from the previously received HTTP responses. In block 804, the function sends the HTTP message identified the authorization URL. In block 805, the function waits for an HTTP-response message. In block 806, the function processes the HTTP-response message and then loops to block 801 to retrieve the next message definition. This processing may include the instantiations of values from the response to be substituted in subsequently processed message definitions.

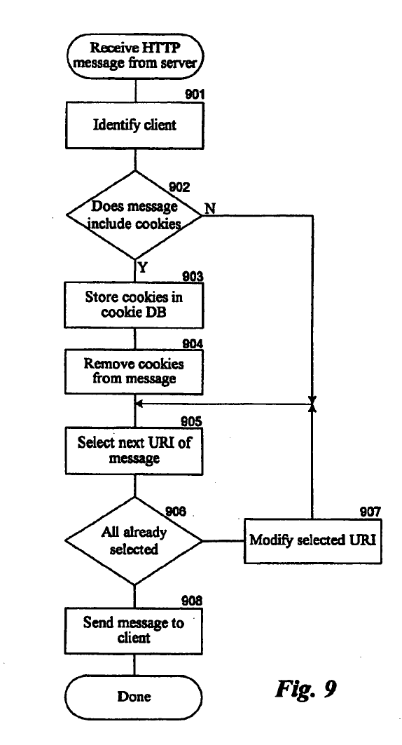

FIG. 9 is a flow diagram illustrating the processing of the “receive HTTP message from a server” function of the forward message component in one embodiment. In block 901, the function identifies the client computer. The portal computer “remembers” which client triggered what forwarded message. When the portal computer forwards a message, it records the associated client computer. When the HTTP-response message arrives at the portal computer from the accessible web site, the portal computer looks up the associated client computer. HTTP-request and HTTP-response messages are implicitly matched with each other. The portal computer transforms the received response by rewriting URLs embedded in the HTML and in HTTP headers, adding some other auxiliary information (e.g., new headers), and sending an HTTP-response message to the client computer. In decision block 902, if the received message includes any cookies, then the function continues at block 903, else the function continues at block 905. In block 903, the function stores the cookies of the received a message in the cookies database identified by the client computer and the domain from which the cookie was sent. In block 904, the function removes the cookies from the message. In block 905, the component selects the next URL, or more generally URI, of the message. The component parses the HTML contained in the message and parses the HTTP headers to identify all URIs contained in the message. In decision block 906, if all the URL's have already been selected, then the function continues at block 908, else the function continues at block 907. In block 907, the function modifies the selected URL to point to the portal web site and then loops to block 905 to select the next URL. The original URL is embedded in the new URL in order to make possible its reconstruction at a later time. In block 908, the function sends the message to the client computer and then completes.

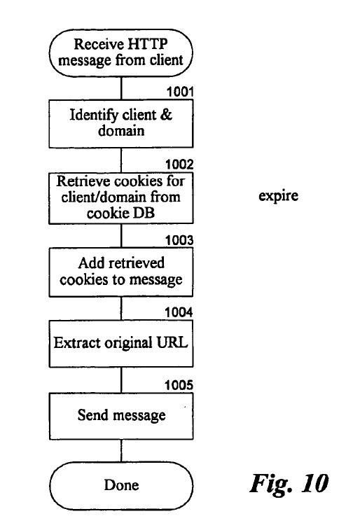

FIG. 10 is a flow diagram illustrating the processing of the “receive HTTP message from client” function of the forward message component in one embodiment. In block 1001, the function identifies the client computer and domain to which the message is directed. The domain is identified by matching URL of the HTTP-request message against all domains known to the portal computer. In block 1002, the function retrieves the cookies for the client computer and domain from the cookie database. The function may also remove expired cookies from the database. In block 1003, the function adds the retrieved cookies to the message. Depending on the authentication scheme, the function may also add special authentication headers to the message (HTTP Basic and Design). In block 1004, the component extracts the original URL pointing to the web site from the modified URL pointing to the portal computer. In block 1005, the component sends the message as indicated by the extracted URL and then completes.

From the above description, it will be appreciated that although the specific embodiments of the invention have been described for purposes of illustration, the invention is not limited to these embodiments. The providers of the accessible web sites can provide updated message definitions to the portal web site when the logon procedure of the accessible web site changes. If multiple portal web sites use the authorization tag format, then the accessible web sites can send the same message definition to each portal web site. The message definitions provide a general mechanism for controlling communications between a server and client computer that is unrelated to logging on to the server. For example, the sequence of messages can be used so that the client computer can retrieve information provided by servers using different message sequences. One skilled in the art will appreciate that various modifications can be made without deviating from the scope of the invention. Accordingly, the invention is defined by the appended claims.

1. A computer-readable medium containing a data structure for specifying a sequence of messages defining a logon procedure for a domain, the data structure comprising:
an identification of the domain; and
a plurality of message definitions, each message definition specifying an HTTP-get message or an HTTP-post message, the message definition for an HTTP-get message specifying a uniform resource identifier and optionally specifying a name, the message definition for an HTTP-post message specifying a uniform resource identifier, optionally specifying a name, and specifying data to be included with the HTTP-post message, wherein the specified data includes a reference to authentication information for a user for the domain.

2. The computer-readable medium of claim 1 wherein data structure is in an XML format.

3. The computer-readable medium of claim 1 wherein a message definition includes a reference to data stored in a response received to a previously sent message defined in the data structure.

4. The computer-readable medium of claim 3 wherein the reference uses a hierarchical naming scheme.

5. The computer-readable medium of claim 4 wherein the hierarchical naming scheme includes a name of a web page, a name of a form, and an attribute of the name of the form.

6. The computer-readable medium of claim 4 wherein the hierarchical naming scheme includes a name of a web page, a name of a form, a name of an input tag of the form, and a value of the input tag.

7. A method in a computer system for communicating with servers using different communications procedures, the method comprising:
for each server, providing message definitions defining the communications procedure for the server, each message definition defining an HTTP-request message to be sent to the server; and
when communications with a server is to occur,
retrieving the provided message definitions for that server; and
sending an HTTP-request message to the server in accordance with the retrieved message definitions.

8. The method of claim 7 wherein a message definition for an HTTP-get message specifies a uniform resource identifier and optionally specifies a name.

9. The method of claim 7 wherein a message definition for an HTTP-post message specifies a uniform resource identifier, optionally specifies a name, and specifies data to be included with the HTTP-post message.

10. The method of claim 9 wherein the communication procedure is for logging on a user to the server and wherein the specified data includes a reference to authentication information for the user for that server.

11. The method of claim 7 wherein a message definition includes a reference to data stored in a message received from the server in response to a previously sent HTTP-request message.

12. The method of claim 11 wherein the reference uses a hierarchical naming scheme.

13. The method of claim 12 wherein the hierarchical naming scheme includes a name of a web page, a name of a form, and an attribute of the name of the form.

14. The method of claim 12 wherein the hierarchical naming scheme includes a name of a web page, a name of a form, a name of an input tag of the form, and a value of the input tag.

15. A computer-readable medium containing a data structure comprising:
an authorization element specifying a form and an http element and having a domain attribute;
a form element specifying a post and a get element;
a get element specifying a name attribute and a url attribute;
a post element specifying a name attribute, a url attribute, and a data attribute; and
an http element that specifies a scheme attribute and a realm attribute.

16. The computer-readable medium of claim 15 wherein the data structure represents an XML schema.

17. A computer-readable medium containing a data structure comprising:
a get element that specifies a format for a message definition for an HTTP-get message, the format including a name attribute and a url attribute; and
a post element that specifies a format for a message definition for an HTTP-post message, the format including a name attribute, a url attribute, and a data attribute.

18. The computer-readable medium of claim 17 wherein the data structure represents an XML schema.

19. A computer-readable medium containing instructions for controlling a computer system to communicate with servers using different communications procedures, by a method comprising:
for each server, providing one or more message definitions defining the communications procedure for the server, each message definition defining a request message to be sent to the server; and
when communications with a server is to occur,
retrieving the provided message definitions for that server; and
sending a request message to the server in accordance with the retrieved message definitions.

20. The computer-readable medium of claim 19 wherein the request messages are HTTP messages.

21. The computer-readable medium of claim 20 wherein a message definition for an HTTP-get message specifies a uniform resource identifier and optionally specifies a name.

22. The computer-readable medium of claim 20 wherein a message definition for an HTTP-post message specifies a uniform resource identifier, optionally specifies a name, and specifies data to be included with the HTTP-post message.

23. The computer-readable medium of claim 22 wherein the communications procedure is for logging on a user to the server and wherein the specified data includes a reference to authentication information for the user for that server.

24. The computer-readable medium of claim 20 wherein a message definition includes a reference to data stored in a message received from the server in response to a previously sent request message.

25. The computer-readable medium of claim 24 wherein the reference uses a hierarchical naming scheme.

26. The computer-readable medium of claim 25 wherein the hierarchical naming scheme includes a name of a web page, a name of a form, and an attribute of the name of the form.

27. The computer-readable medium of claim 25 wherein the hierarchical naming scheme includes a name of a web page, a name of a form, a name of an input tag of the form, and a value of the input tag.

28. A computer-readable medium containing a data structure for specifying a sequence of messages defining a communications procedure for a domain, the data structure comprising:
an identification of the domain; and
a plurality of message definitions, each message definition specifying a request message, the message definition for a request message specifying a uniform resource identifier and specifying a name
wherein the communications with the domain occurs by sending messages in accordance with the message definitions.

29. The computer-readable medium of claim 28 wherein the data structure includes sequences of message definition defining communications procedures for more than one domain.

30. The computer-readable medium of claim 28 wherein data structure is in an XML format.

31. The computer-readable medium of claim 28 wherein a message definition includes a reference to data stored in a response received to a previously sent message defined in the data structure.

32. The computer-readable medium of claim 31 wherein the reference uses a hierarchical naming scheme.

33. The computer-readable medium of claim 32 wherein the hierarchical naming scheme includes a name of a web page, a name of a form, and an attribute of the name of the form.

34. The computer-readable medium of claim 32 wherein the hierarchical naming scheme includes a name of a web page, a name of a form, a name of an input tag of the form, and a value of the input tag.

35. A system for communicating with servers using different communications procedures, comprising:
means for providing for each server a set of one or more message definitions defining the communications procedure for the server, each message definition defining a request message to be sent to the server; and
means for retrieving a provided set of one or more message definition for a server when communications with that server is to occur and sending one or more request messages to the server in accordance with the retrieved set of one or more message definitions.

36. The system of claim 35 wherein the request messages are HTTP messages.

37. The system of claim 36 wherein a message definition for an HTTP-get message specifies a uniform resource identifier and optionally specifies a name.

38. The system of claim 36 wherein a message definition for an HTTP-post message specifies a uniform resource identifier, optionally specifies a name, and specifies data to be included with the HTTP-post message.

39. The system of claim 35 wherein a message definition includes a reference to data stored in a message received from the server in response to a previously sent request message.

40. The system of claim 39 wherein the reference uses a hierarchical naming scheme.
